(19) United States
(12) Patent Application Publication
(10) Pub. No.: US 2024/0051805 A1
(43) Pub. Date: Feb. 15, 2024

(54) TRANSPORTABLE FOLDABLE LIFTING PLATFORM FOR VEHICLES

(71) Applicant: Anton JAKSE, Novomesto (SI)

(72) Inventor: Anton JAKSE, Novomesto (SI)

(21) Appl. No.: 17/766,478

(22) PCT Filed: Oct. 22, 2020
(86) PCT No.: PCT/SI2020/050022

§ 371 Date: Apr. 4, 2022

(30) Foreign Application Priority Data
Oct. 23, 2019 (SI) P-201900202

(51) Int. Cl. B66F 7/06

(52) U.S. Cl. CPC B66F 7/0683; B66F 7/0625

(57) ABSTRACT

The present invention belongs to the field of frames and mechanisms for lifting vehicles and other heavier objects or persons. The invention relates to a transportable foldable lifting platform preferably useful for lifting vehicles with the purpose of their exposition. The essence of the invention is in that it comprises: ⋅a base triangular construction (2) and suitable plate and/or sleds (21) for a vehicle, arranged on the base triangular construction to which the vehicle may be driven; ⋅three three-part lifting legs (3), wherein each of the lifting legs is equipped with at least one hydraulic cylinder (34) and with a parallelogram mechanism, so that the parallelogram can be folded or extended depending on the position of both parts of the lifting legs, which is defined with each of the hydraulic cylinders controlled with suitable hydraulic valves; ⋅a drive part; and ⋅electronics for controlling hydraulic valves of the hydraulic cylinders, movement of each of the lifting legs and ensures self-adjustability of the platform.

### FIELD OF THE INVENTION

The present invention belongs to the field of lifting devices, more particularly to the field of frames and mechanisms for lifting vehicles and other heavier objects or persons. The invention relates to a transportable foldable lifting platform preferably useful for lifting vehicles with the purpose of their exposition.

### BACKGROUND OF THE INVENTION AND THE TECHNICAL PROBLEM

Vehicles in exhibition spaces are usually parked on the floor of the space, wherein some rotatable platforms may be found at exhibitions, so that the vehicle is visible from all angles. Such solution is described in patent EP 0 851 076. Rotatable platforms are installed on the ground and cannot be lifted. In order to lift a car onto a particular height stands may be used, but they cannot be adjusted or rotated.

The technical problem is a constructional design of a lifting platform for a vehicle, which will enable lifting of the vehicle, placing it at an angle and/or rotate, wherein the said lifting platform has to be transportable and adjustable to the surface, so that it can be easily folded and moved to a different location. It is required that the platform has a height as low as possible in order to avoid use of loading ramps, which additionally complicate installation and exhibition of the vehicle. In addition, it is required that the platform is adjustable to the terrain, where it will be used, as uneven floors are common.

### STATE OF THE ART

Known solutions of vehicle lifting devices are intended for parking garages, such as the one described in patent FR2461078, but these solutions differ from the present invention in their construction. Also lifting devices for repairing vehicles have a different construction. For example, document DE3529069 describes separate parallel sleds onto which a vehicle can be driven. The vehicle is then lifted with a scissor mechanism installed in the sleds. Utility model DE102004009092 discloses a similar solution, but the sleds are connected with each other, while the utility model DE102010027889 the sleds are connected in the bottom part.

Utility models DE202006006890 and DE202005004378 describe a device, which is designed as a trailer for mounting onto a suitable vehicle, wherein the trailer has a platform, which can be raised using a scissor mechanism. In this way the vehicle to be repaired can be lifted to a suitable height. The design of the platform differs from the present invention, wherein the transportability of the platform is ensured in a different manner.

Known solutions are either not suitable for movement or do not enable lifting to higher points needed to exhibit a vehicle. The lifting sleds are, namely, intended for lifting the vehicle just enough to enable urgent repair. At the same time their installation without attachment to the base is impossible. In case they were not attached to the base, these constructions would suffer from low lateral stability, which consequently leads to a less safe use.

### Description of the Solution of the Technical Problem

The aim of the invention is to solve the shortcomings of the above-described known solutions and consequently to ensure a transportable foldable lifting platform that will be modular and will have a height as low as possible, wherein one person will be able to install the platform.

The essence of the transportable foldable lifting platform according to the invention is in that it comprises:
Triangular base frame and a suitable plate and/or sleds for the vehicle, wherein the plate and/or sleds are mounted onto the base frame so as to allow the vehicle to be driven onto the platform;
Three three-part lifting legs, which may be equipped with removable wheels for easier movement between different locations, where the platform is to be installed;
Each of the lifting legs is equipped with at least one hydraulic cylinder, preferably with two hydraulic cylinders and a parallogram mechanism (parallelogram stirrup), wherein one part of the parallelogram mechanism is mounted onto the base frame along which it linearly slides or moves, while the second part is mounted onto the bottom part of the lifting leg, so that the parallelogram can be folded or extended depending on the position of both parts of the lifting legs defined by each of the hydraulic cylinders, and wherein one part of the cylinder is mounted into the bottom part of the support leg and the other one into the upper part of the lifting leg or a part of the base frame, where the latter is attached to the lifting leg, and wherein said hydraulic cylinders are controlled with suitable valves, preferably with proportional hydraulic valves;
Additionally the platform may be equipped with a small lifting mechanism comprising two handles and connected with an axis, onto which at least one hydraulic cylinder of the lifting leg may be attached, wherein the second part of at least one hydraulic cylinder is attached directly to the small lifting mechanism;
A drive part, which is preferably hydraulics and an electric motor or suitable battery;
Electronics for controlling the hydraulic valves of the hydraulic cylinders, movement of each of the lifting legs as well as ensuring self-adjustability of the platform.

Three-part lifting legs comprise a bottom part, which is arranged to be in contact with a surface, and an upper part, which is arranged to be in the same height as the base frame. One of the lifting legs is welded onto the base frame, while the other two lifting legs are mounted in suitable hinges, so that they can be folded for transportation. In the working position, however, these two legs are screwed onto the base frame.

Further, each of the bottom part of each lifting leg, which will be in the contact with the surface, is preferably provided with a plate and a joint that enables movement in all directions. Said joint also contributes to adjustability of the lifting platform with regards to the surface, on which the platform is installed. Due to presence of lifting legs the platform according to the invention does not require use of any base or foundations. Said lifting legs are arranged at a distance one from another, so that the gravity centre of the platform with our without the car is in the middle and cannot tip over. The removable wheels may be installed for transportation, preferably into a suitable bearing that enables rigid mounting in the lifting leg, so that the wheels may be locked in the required position and unlocked in case the wheels are to be removed.

The three-part lifting legs has at least one hydraulic cylinder for ensuring lifting, preferably two hydraulic cylinders are used in order to ensure more reliable lifting. Each cylinder may have its own control valve, preferably proportional hydraulic valves, or pairs of cylinders installed in the same lifting leg have a joint valve, wherein the hydraulic pipes are led to the middle part of the base frame in the interior pipe of the base frame. Preferably the piston is attached to the bottom part of the lifting leg with a mounting bushing, while the cylinder is attached to the upper part. In case the small lifting mechanism is used, the cylinder is attached to the upper part together with the sail small lifting mechanism. Such mounting of the hydraulic cylinders into the lifting legs enables optimal placement of hydraulic pipes, as they are less bent.

The smaller lifting mechanism comprises two handles, which are basically mounted via a common bolt of the lifting leg and serves as their pivot or fulcrum. The adjacent bolt on the lifting handles is intended for mounting hydraulic cylinders (it is possible to use one), which upon its movement causes rotation of both handles around the said pivot. The handles are shaped as involutes and end with a roller. Their shape enables the mechanism to achieve suitable lifting forces in the lowest position despite the horizontal position of the hydraulic cylinders. The ends of handles are independent, as in the basic position the legs are folded in the interior of the ends of the bottom part of lifting legs. In case the small lifting mechanism is used the second part of at least one hydraulic cylinder of the lifting leg may be attached directly to the small lifting mechanism, or, as already described above, the second part of at least one hydraulic cylinder is attached to the upper part of the lifting leg or onto a part of the base frame.

The base frame comprises an outer triangular casing (frame), which is divided along the middle with a middle part, preferably welded from two rods that stretch to approximate middle of the height of the triangle. Along the middle part two smaller right-angled triangles are provided on each side, said triangles also forming a part of the triangular frame. In the inner triangular frame electronics is installed, wherein said electronics preferably comprise a gyroscope for following the level of the platform and consequently represents additional control of lifting and lowering of the platform. The electronics may be any suitable electronics known to the skilled person and its design is not the subject-matter of this invention, as it can be adapted in many ways with regards to the mechanical and hydraulic parts. A suitable drive system, such as a drive aggregate—electrical motor with a pump and reservoir may be installed outside of the frame and connected to the hydraulic pipes, while a suitable drive system may also be installed inside the frame. Control of the platform according to the invention is performed in any suitable way allowing remote control, while the control buttons may be provided on a cable that connects the drive unit outside the platform and the lifting platform. Onto the hypotenuse of each of the right-angled triangles one lifting leg is mounted, preferably with a hinge, so that it can be rotated into a folded position for transport, when the lifting legs are in their lowermost position. The outer triangular frame is due to its foldable nature movable in corners, wherein two sides are rotated so that they become parallel with the two folded lifting legs.

Preferably the transportable foldable platform is designed so that the base frame is provided with a sheet metal plate, sleds for a vehicle or a steel plate, onto which a vehicle can be driven, wherein the plate may be rotatable around its vertical axis in any known suitable way. This is especially suitable if the platform will be used in exhibitions or showrooms. The plate, sleds or steel plate may be attached to the base frame in any known way, wherein the sleds are preferably mounted onto the base frame with hinges, so that the sleds may be moved with regards to the distance between vehicle wheels. The sleds may also be removed if needed.

Optionally the transportable lifting platform is equipped with the possibility of incline, wherein this can be performed regardless of the upper plate, sled or steel plate, its rotation or absence thereof. The incline is enabled with two additional two-sidedly operating hydraulic cylinders on one of the lifting legs, said additional hydraulic cylinders being parallel to the basic hydraulic cylinder and are located on the sides of the basic hydraulic cylinder, wherein said additional hydraulic cylinders are controlled with a suitable valve, preferably with a 1/0 valve controlled with electronics. The cylinders directly push the connecting rod shaft on the lifting leg with additional hydraulic cylinders, wherein the said connecting rod shaft is in horizontal position. The rod shaft is mounted into the lifting leg movable around the hinge and can be moved so that the lifting platform is inclined in one part. Self-locking of the connecting rod shaft enables suitable position of the rod shaft, as the weight and the geometry of this assembly do not allow uncontrolled lowering of the incline.

From the security point of view the lifting platform is preferably equipped with a security system, preferably with a system for sensing strong wind, connected to the electronics, which will trigger automatic lowering of the platform and will at the same time trigger an alarm that will notify the user or the platform operator. One of the possible embodiments is that the system measures pressure in the cylinders and in case of discrepancy determines that the construction is laterally loaded. Upon determined discrepancy the electronics ensure lowering of the platform as well as a notification to the manager of the platform about the change of platform status. A second possible embodiment of the system is that it weighs the pressure of the leg onto the surface or even tension of the frame, which again in case of discrepancy causes lowering of the platform. A third possible embodiment is a device for measuring height, preferably installed on each of the lifting legs, wherein all data would be followed with electronics and computer. In case of difference in heights of any of the lifting legs, which is not required (for the incline, for example), the electronics lowers the platform. Even in absence of the safety system a possible lowering of the plate would be sensed by the gyroscope as a change in the incline, which can be sensed by the electronics and consequently the platform would be lowered.

Electronics or the optional gyroscope, respectively, follow the incline of the platform and send the data to a computer. The computer processes the data, sends the information to the circuit which controls hydraulic valves, preferably proportional hydraulic valves, used for adjustment to terrain, wherein usual valves are sufficient for the parallel lifting without adaptation to the terrain. The whole platform is first automatically adjusted with regards to the surface and then lifted onto the required height, wherein the lifting is always performed parallelly, i.e. the lifting legs ensure lifting and maintain parallelism (both functions are performed by the same mechanism). The system has against uncontrolled lowering an additional hydraulic valve functioning as a lock that prevents any lowering without a suitable command. This lock is installed directly onto the pressure part of the hydraulic cylinder of each lifting leg, which is indirectly loaded with the force of gravity. In case additional incline of the platform is used, the incline will be performed only when the platform reaches its final, required height.

The transportable lifting platform according to any of the possible embodiments may be made from any suitable material, which enables lifting of vehicles, wherein the preferable option is steel. The platform according to the invention may be additionally equipped with a canvas or any similar material, which is mounted into the bottom part of the lifting legs and into the base frame of the platform, so that upon lifting of the plate the canvas is raised and consequently covers the interior of the platform. This secures the construction of the platform and hydraulic tubes, while at the same time the canvas or any other material with suitable air permeability enables lighting or promotional function. The said canvas may be mounted to the upper side of the base frame, for example under the sleds.

The transportable lifting platform according to the invention may be used in closed or open spaces, wherein it can be set in in salerooms, showrooms, stores, skiing spaces, sporting venues and similar. Depending on the construction and length of the lifting legs as well as hydraulic cylinder the transportable platform according to the invention enables lifting up to 10 metres, preferably between 3 and 7 metres.

In the scope of the invention as described herein and defined in the claims other embodiments of the platform are possible, which are obvious to the person skilled in the art, which does not limit the essence of the invention as described herein and defined in the claims. During development of the invention it has been determined that the described transportable foldable lifting platform could also be used for lifting and/or exhibition of other products, not only vehicles. At the same time the reliable operation of the platform can be used as a stage, for example for shows and concerts, in case the dimension of the constructional elements is adjusted.

The transportable foldable lifting platform according to the invention will be described in further detail based on exemplary embodiments and figures, which show:

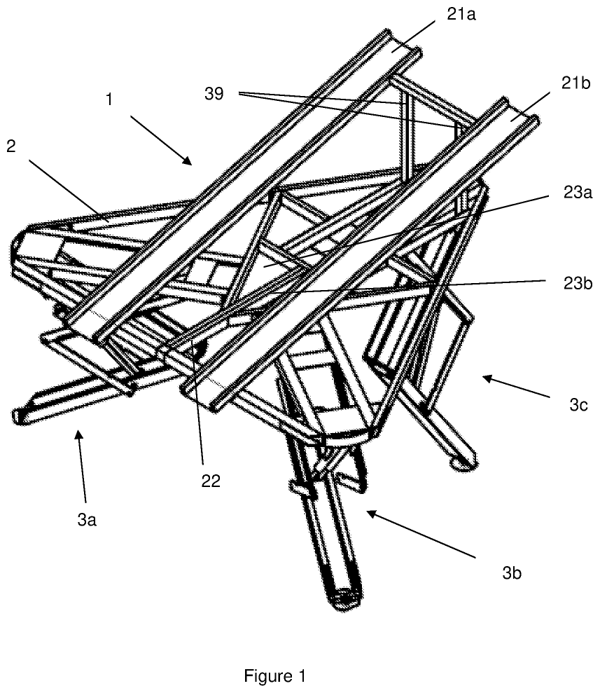

FIG. 1 The transportable foldable lifting platform according to a possible embodiment

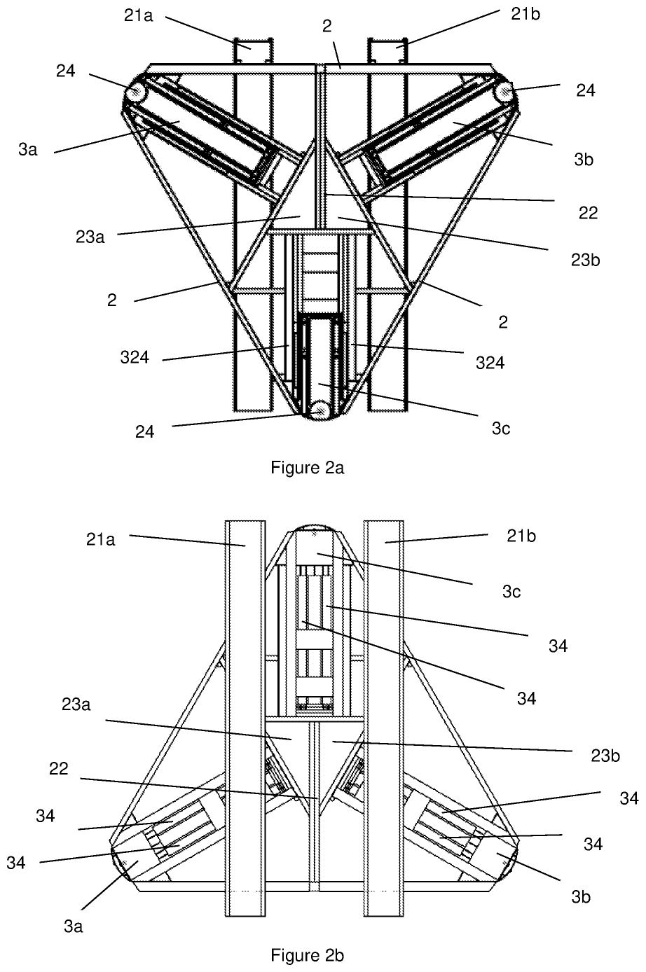

FIG. 2a The transportable foldable lifting platform shown in FIG. 1 from below

FIG. 2b Plan view of the transportable foldable lifting platform shown in FIG. 1

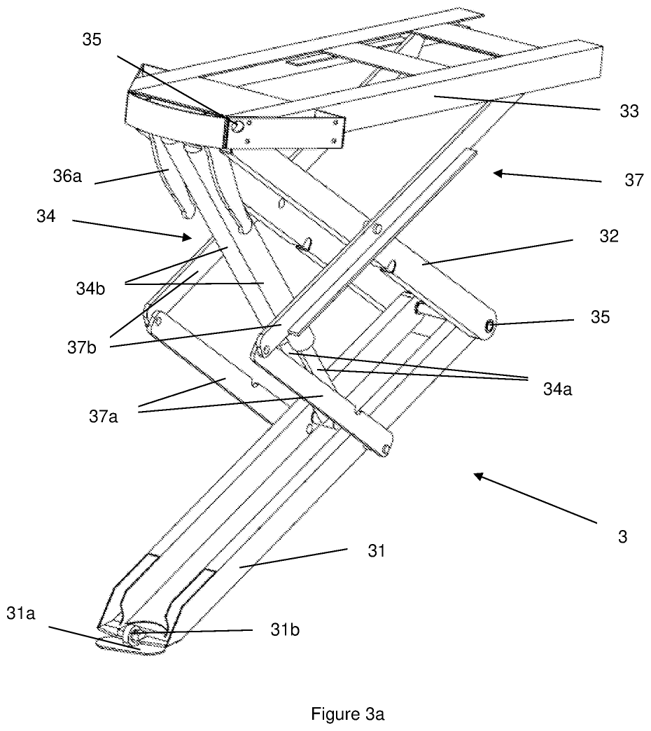

FIG. 3a The three-part lifting leg in a partially extended state

FIG. 3b Side view of the three-part lifting leg in a partially extended state

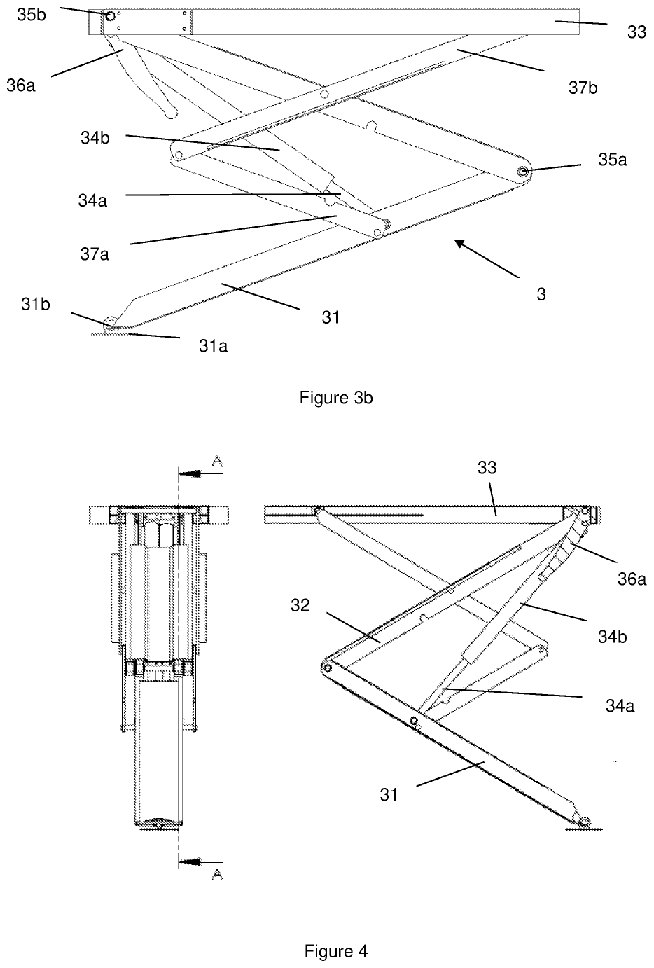

FIG. 4 The three-part lifting leg in cross-section, in which the additional smaller lifting mechanism is visible

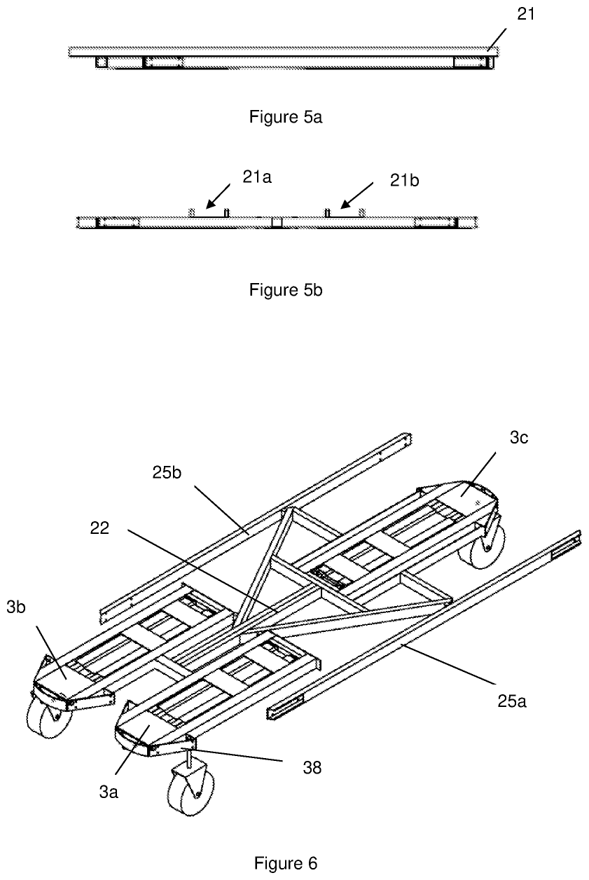

FIG. 5 The transportable foldable lifting platform in the lowest position from the side (a) and in elevation view (b)

FIG. 6 The transportable foldable lifting platform in the folded state

FIGS. 1, 2a and 2b show the transportable foldable lifting platform 1 in a side view, view from below as well as in plan view in a partially extended state, wherein to the base frame 2 sleds 21a, 21b for a vehicle are provided. The base frame 2 is divided to the approximate half of the height of the triangle with a middle part 22 welded from two rods. Along the middle part 22 on both sides are two smaller right-angled triangles 23a, 23b, which are also a part of an inner triangular frame. In the inner triangular frame electronics and gyroscope and suitable drive mechanism (not shown in the figures) are mounted. The platform 1 has three three-part lifting legs 3a, 3b, 3c, of which each has a bottom part, a middle part and an upper part, each of the legs is provided with two hydraulic cylinders and a parallelogram mechanism. Onto the hypotenuse of each of right-angled triangles 23a, 23a one lifting leg 3a, 3b is mounted, preferably via a hinge, so that rotation into a folded position for transport is enabled once the lifting legs are in the lowermost position. The third lifting leg 3c is welded to the base frame 2. FIG. 2a also shows a space 324 into which two additional hydraulic cylinders for the optional include of the lifting platform may be installed.

FIG. 1 shows an embodiment of the transportable foldable lifting platform with the possibility of incline, which is enabled with additional two-side operating hydraulic cylinders on one of the lifting legs, which are parallel to at least one of the basic hydraulic cylinders and which are located at the sides of the basic cylinder in place 324 and a suitable valve, preferably a 1/0 valve, which is also controlled with electronics. The cylinders directly push the connecting rod shaft 39, which is in a horizontal position. The rod shaft is mounted into the lifting leg movable around the hinge and can be moved so that the lifting platform is inclined in one part.

FIG. 3 shows one of the lifting legs in a partially extended state in elevation and side view. The lifting leg 3 comprises a bottom part 31 having a plate 31a and a joint 31b, which enables rotation in all directions, which improves adjustability to the terrain/surface. The middle part 32 of the lifting leg is connected with a bottom part 31 and an upper part 33 with suitable hinges 35, which can create an arbitrary angle between pairs of parts (bottom and middle as well as middle and upper). In the approximate middle of the bottom part 31 pistons 34a of both hydraulic cylinders 34, while the cylinders 34b of both hydraulic cylinders are mounted in the upper part 33 of the lifting leg 3. The two-part parallelogram mechanism is mounted in the approximate middle of the bottom part 31 and in the upper part 33, namely not in the same part where the hydraulic cylinders 34 are mounted. The upper part of the parallelogram mechanism is additionally mounted with a bolt, around which it is rotated in the middle part 32. In the upper part 33 a small lifting mechanism 36 with a handle 36a is mounted.

FIG. 4 shows the smaller lifting mechanism 4, which comprises two handles 36a, which are basically mounted via a common bolt 35 of the lifting leg 3 and serves as their own fulcrum. The adjacent bolt on the lifting hand is intended for mounting hydraulic cylinders (or only one hydraulic cylinder), which upon their movement causes rotation of both handles 36a around the fulcrum 35. The handles 36a are shaped as as involutes and end with a roller. Their shape enables the mechanism to achieve suitable lifting forces in the lowest position despite the horizontal position of the hydraulic cylinders. The ends of handles are independent, as in the basic position the legs are folded in the interior of the ends of the bottom part of lifting legs.

FIG. 5 shows the transportable foldable lifting platform in the lowest state, when the hydraulic cylinders and consequently the lifting legs are parallel to the surface. FIG. 6 shows the transportable foldable lifting platform in the folded state, wherein the outer triangular frame 2 is due to foldability movable in the corners 24. For folding the transportable lifting platform two of the sides 25a, 25b are rotated so that they become parallel to the two folded lifting legs 3a, 3b. At the end 38 of the upper part 33 of the lifting legs a removably mounted wheel is provided, wherein the wheel can be mounted and removed in any suitable known way.

1. Transportable foldable lifting platform for vehicles, which comprises at least the following:
a base triangular construction and suitable plate and/or sleds for a vehicle, arranged on the base frame to which the vehicle, object or a person may be placed;
three three-part lifting legs, wherein each of the lifting legs is equipped with:
at least one hydraulic cylinder, preferably with two hydraulic cylinders, wherein one part of the cylinder is mounted into a bottom part of the lifting leg, while the second part of the cylinder is mounted in an upper part of the lifting leg or a part of the base frame, and wherein said hydraulic cylinders are controlled with suitable valves, preferably with proportional hydraulic valves, and
a parallelogram mechanism, of which one part is mounted on the base frame along which it linearly slides or moves, and the second part is mounted on the bottom part of the lifting leg, so that the parallelogram can be folded or extended depending on the position of both parts of the lifting legs defined with each of the hydraulic cylinders;
a drive part, which is preferably hydraulics and an electric motor or suitable batteries; and
electronics for controlling hydraulic valves of the hydraulic cylinders, movement of each of the lifting legs and ensures self-adjustability of the platform.

2. Transportable foldable lifting platform for vehicles according to claim 1, characterized in that the three-part lifting legs are arranged evenly with regards to the base frame, so that the center of gravity of the platform is in the middle, wherein the said lifting legs comprise:
a bottom part, which is arranged to be in contact with a surface, preferably the bottom part is equipped with a plate and a joint, which enables movement in all axes,
a middle part, and
an upper part, which is in the same height as the base frame,
wherein one of the lifting legs is welded to the base frame, while the other two lifting legs are mounted in hinges, so that they can be folded for transportation.

3. Transportable foldable lifting platform for vehicles according to claim 1 or claim 2, characterized in that the three-part lifting legs are equipped with at least one hydraulic cylinder for ensuring lifting, preferably each leg has two hydraulic cylinders, wherein the piston is with a mounting bushing attached to the bottom part of the lifting leg, while the cylinder is attached to the upper part, wherein each cylinder has its own control valve, preferably proportional hydraulic valve, or pairs of cylinders of one leg are controlled with one valve, while hydraulic tubes are led to the middle part of the base frame in the interior of the tube of base frame.

4. Transportable foldable lifting platform for vehicles according to any of the preceding claims, characterized in that the three-part lifting legs are equipped with removable wheels, which can be installed for transportation into a suitable mounting that enables a rigid mounting in the lifting leg, so that the wheels may be locked and unlocked for removal.

5. Transportable foldable lifting platform for vehicles according to any of the preceding claims, characterized in that the said platform has a small lifting mechanism comprising two handles, which are mounted via a common bolt one of the lifting legs serving as their pivot, wherein an adjacent bolt on the lifting handle is intended for mounting at least one hydraulic cylinder of the lifting leg, which upon its movement causes rotation of both handles around the pivot; and in that the second part of at least one hydraulic cylinder may be attached directly to the small lifting mechanism.

6. Transportable foldable lifting platform for vehicles according to any of the preceding claims, characterized in that the base construction comprises an outer triangular frame, which is divided along the middle with a middle part, preferably welded from two rods that stretch to approximate middle of the height of the triangle; along the middle part two smaller right-angled triangles are provided on each side, said triangles also forming a part of the inner triangular frame, in which electronics, preferably comprising a gyroscope, are installed for following the level of the platform and consequently controlling of lifting and determining the state of the platform; onto the hypotenuse of each of the right-angled triangles one lifting leg is mounted, preferably with a hinge, so that it can be rotated into a folded position for transport, when the lifting legs are in their lowermost position; the outer triangular frame is due to its foldable nature movable in corners, wherein two sides are rotated so that they become parallel with the two folded lifting legs.

7. Transportable foldable lifting platform for vehicles according to any of the preceding claims, characterized in that on the base frame a plate, sled for vehicles or steel upper platform is installed, wherein the latter may be rotatable around its vertical axis in any known suitable way.

8. Transportable foldable lifting platform for vehicles according to any of the preceding claims, characterized in that the said platform is equipped with a possibility to incline, which is enabled with additional two-sidedly operating hydraulic cylinders on one of the lifting legs, wherein the additional hydraulic cylinders are parallel with regards to at least one hydraulic cylinder and are located at the sides of the said primary cylinder, and wherein the additional hydraulic cylinders are controlled with a suitable valve, preferably with a 1/0 valve, which is also controlled with electronics; and wherein the additional hydraulic cylinders directly push a connecting rod shaft positioned horizontally and mounted into the lifting leg rotating around the hinge, due to this mounting the connecting rod shaft is moved so that the platform is inclined on one side.

9. Transportable foldable lifting platform for vehicles according to any of the preceding claims, characterized in that the said platform is additionally equipped with a hydraulic valve functioning as a lock, which prevents any lowering without command, said hydraulic valve being installed directly to the pressure part of the hydraulic cylinder onto each lifting leg, which is indirectly loaded with gravity force, and in that the said platform may be equipped with a safety system connected to electronics, which is arranged to trigger automatic lowering of the platform upon sensed discrepancies and the system is further arranged to trigger an alarm for notifying a user of a manager or the platform.

10. Transportable foldable lifting platform for vehicles according to the preceding claim, characterized in that the safety system may measure:
Pressure in cylinders and in case of discrepancy means that the construction of the platform is laterally loaded, or
Pressure of the lifting leg onto the surface or tension of the frame, which can trigger lowering of the platform in case of discrepancy; or
Height of the platform, preferably on each of the lifting legs;
wherein all measured parameters are followed with electronics and computer.

11. Transportable foldable lifting platform for vehicles according to any of the preceding claims, characterized in that the suitable drive system, such as an electric motor with a pump and reservoir, is installed outside the frame and connected with hydraulic tubes, or the suitable drive system is installed inside the frame.

12. Transportable foldable lifting platform for vehicles according to any of the preceding claims, characterized in that the electronics or the optional gyroscope is arranged to measure inclination of the platform and to send data to a computer; the computer is arranged to process the data and to send the information to a circuit for controlling suitable valves, preferably proportional hydraulic valves; and that the whole platform is arranged to be adjusted to the terrain and afterwards to lift to a required height, wherein lifting is always performed in parallel.

13. Transportable foldable lifting platform for vehicles according to any of the preceding claims, characterized in that the platform is made of any suitable material, preferably steel.

14. Transportable foldable lifting platform for vehicles according to any of the preceding claims, characterized in that the said platform is additionally equipped with a canvas or similar material, which is mounted into the bottom part of the lifting legs and to the base frame of the platform, so that upon lifting of the platform the canvas is raised and covers the interior of the whole platform.

15. Transportable foldable lifting platform for vehicles according to any of the preceding claims, characterized in that the platform may be used in closed or open spaces, wherein the platform may be installed in vehicle showrooms, shops, skiing areas, sporting events and similar.
